(19) United States
(12) Patent Application Publication
(10) Pub. No.: US 2006/0172156 A1
(43) Pub. Date: Aug. 3, 2006

(54) Magnetic recording medium and process for producing same

(76) Inventors: Katsunori Maeshima, Miyagi (JP); Masaru Terakawa, Miyagi (JP); Noboru Sekiguchi, Miyagi (JP); Takeshi Akasaka, Miyagi (JP); Yuichi Masuzawa, Miyagi (JP)

Correspondence Address: SONNENSCHEIN NATH & ROSENTHAL;Sears Tower, Wacker Drive Station, P.O. Box 061080, Chicago, IL, 60606-1080, US

(21) Appl. No.: 11/335,122

(22) Filed: Jan. 19, 2006

(30) Foreign Application Priority Data
Jan. 28, 2005 (JP) P2005-021700

(51) Int. Cl. G11B 5/716

(52) U.S. Cl. 428/840; 427/127

(57) ABSTRACT

A magnetic recording medium includes a non-magnetic supporter; a lower non-magnetic layer containing at least inorganic particles and a binder resin; and a magnetic layer containing at least a magnetic powder and a binder resin and having a thickness of 100 nm or less, the lower non-magnetic layer and the magnetic layer being laminated on a main surface of the non-magnetic supporter, wherein the magnetic layer is formed by a process including applying a paint for forming the lower non-magnetic layer; drying the applied paint; and applying a magnetic paint while the lower non-magnetic layer is kept in a film state after drying.

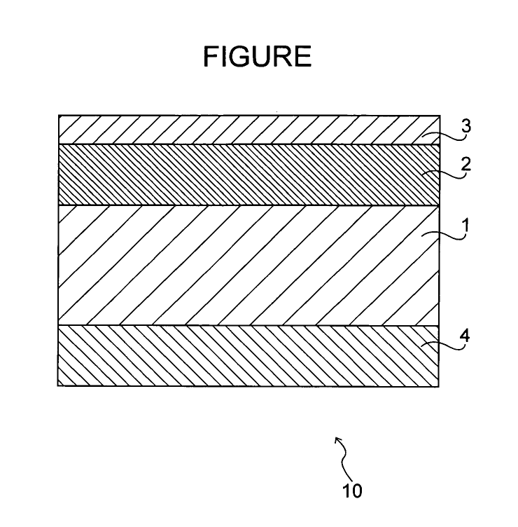

### CROSS REFERENCES TO RELATED APPLICATIONS

The present invention contains subject matter related to Japanese Patent Application JP 2005-021700 filed in the Japanese Patent Office on Jan. 28, 2005, the entire contents of which are incorporated herein by reference.

### BACKGROUND OF THE INVENTION

1. Field of the Invention

The present invention relates to a high-density magnetic recording medium having an extremely thin magnetic layer (recording layer) and also relates to a process for producing the magnetic recording medium.

2. Description of the Related Art

In recent years, an increase in the amount of information required to be stored in a recording medium with developments in digital recording and the like may require trends toward higher recording density and shorter wavelength recording.

In magnetic recording media applied to systems each including, in particular, a highly sensitive magnetic read head, such as a magnetoresistive head (MR head) or a giant magnetoresistive head (GMR head), in order to achieve shorter wavelength output and to improve electromagnetic conversion characteristics (C/N characteristics), magnetic properties have been improved. Furthermore, in order to reduce spacing loss and modulation noise, the thickness of the magnetic layer has been reduced, and the surface of the magnetic layer has been smoothed.

As such magnetic recording media each including a thin magnetic layer (recording layer), magnetic recording media each including a lower non-magnetic layer, a magnetic layer, and a supporter, the lower non-magnetic layer and the magnetic layer being laminated on the supporter, have been developed and commercially manufactured.

An exemplary film-forming method for producing such a magnetic recording medium including laminated thin films is a wet-on-wet method of applying a non-magnetic paint to form a lower non-magnetic layer, and applying a magnetic dispersion at one time or sequentially onto the lower non-magnetic layer being in a wet state.

This film-forming method is advantageous in view of productivity and cost. However, the method has the following problems: when viscoelastic properties of the paint for forming the lower non-magnetic layer are not close to those of the dispersion for forming the upper magnetic layer, lamination cannot be performed, thereby causing application defects and the deterioration of the surface state of the magnetic layer. Thus, a magnetic recording medium having satisfactory surface properties is not produced.

To overcome such problems, various studies have been performed. However, in the wet-on-wet method in which the dispersion for forming the upper layer is applied onto the lower non-magnetic layer being in the wet state, a problem in which application defects due to the irregularity of the interface between the lower non-magnetic layer and the magnetic layer inevitably occur still remains. The application defects cause generation of noise, thus degrading electromagnetic conversion characteristics. These disadvantages are obstacles to achieve further reduction in the thickness of the recording layer.

On the other hand, as another method for laminating layers by application of paint, for example, Japanese Unexamined Patent Application Publication Nos. 2000-207732 and 2001-84553 each propose a method of forming a lower non-magnetic layer by application of paint, drying the resulting layer, calendaring the layer to smooth the surface, curing the layer by electron-beam irradiation, and forming a magnetic layer.

Unlike the above-described wet-on-wet method, in this method, since a magnetic paint is applied after drying the lower non-magnetic layer, it is difficult for application defects due to the irregularities of the interface between the lower non-magnetic layer and the magnetic layer to occur. In particular, in an ultrahigh-density magnetic recording medium having an extremely thin magnetic layer, this method has an advantage in that it is difficult for a minute pinhole to occur.

However, when an upper magnetic layer having an extremely small thickness of 100 nm is formed by the wet-on-dry method described above, the drying speed of the upper magnetic layer is a very high during the production. As a result, the degree of orientation of the magnetic powder is not increased in performing magnetic field orientation treatment as a post production treatment. Thereby, disadvantageously, satisfactory electromagnetic conversion characteristics are not achieved.

To overcome such problems, it is necessary to reduce the drying speed of the upper magnetic layer.

For example, Japanese Unexamined Patent Application Publication Nos. 9-185822 and 2001-84584 each propose a method of forming a back coat layer in advance by applying a predetermined dispersion on one main surface opposite the other main surface on which a magnetic layer (recording layer) is to be formed, and forming an upper magnetic layer by application on an already-formed lower non-magnetic layer while the back coat layer is in a wet state.

### SUMMARY OF THE INVENTION

However, in recent years, to achieve a higher recording density, a magnetic layer (recording layer) has been required to have an extremely small thickness of 100 nm or less. In some methods proposed in the above-described known technique, the drying speed of a thin magnetic layer cannot be effectively reduced. As a result, the degree of orientation of the magnetic powder is not increased to a practical level.

Furthermore, when the drying speed of the magnetic layer is reduced by using wettability of a back coat layer, the back coat layer is transferred onto the surface of the magnetic layer in winding a long magnetic recording medium, thereby disadvantageously degrading surface properties and electromagnetic conversion characteristics.

Accordingly, in the present invention, it is desirable to provide a high-density magnetic recording medium laminated by application, the magnetic recording medium preventing the occurrence of a pinhole in an extremely thin magnetic layer, eliminating defects in orientation, and having satisfactory film quality, surface properties, and electromagnetic conversion characteristics.

According to an embodiment of the present invention, there is provided a magnetic recording medium including a non-magnetic supporter; a lower non-magnetic layer containing at least inorganic particles and a binder resin; and a magnetic layer containing at least a magnetic powder and a binder resin and having a thickness of 100 nm or less, the lower non-magnetic layer and the magnetic layer being laminated on a main surface of the non-magnetic supporter, wherein the magnetic layer is formed by a process including applying a paint for forming the lower non-magnetic layer; drying the applied paint; and applying a magnetic paint while the lower non-magnetic layer is kept in a film state after drying.

According to an embodiment of the present invention, there is also provided a process for producing a magnetic recording medium, the process including applying a non-magnetic paint containing according to inorganic particles dispersed in a binder resin onto at least one main surface of a non-magnetic supporter; drying the applied paint to form a lower non-magnetic layer; and applying a magnetic paint containing at least a magnetic powder dispersed in a binder resin onto the lower non-magnetic layer that is maintained in a film state after drying, to form a magnetic layer.

According to an embodiment of the present invention, in laminating the lower non-magnetic layer and the magnetic layer, the lower non-magnetic layer is formed, drying is performed, and the magnetic paint is applied onto the lower non-magnetic layer that is maintained in the film state after drying to form the magnetic layer. Therefore, most of the organic solvent in the paint for forming the upper recording layer (magnetic layer) penetrate into the lower non-magnetic layer. In the subsequent drying step, the solvent is transferred from the lower non-magnetic layer to the upper recording layer (magnetic layer) again, thereby reducing the drying speed of the magnetic layer to achieve high orientation after magnetic orientation treatment.

According to an embodiment of the present invention, after the lower non-magnetic layer is dried, the magnetic paint is applied without any surface treatment, such as calendaring or curing. Therefore, the organic solvent in the magnetic paint can be allowed to penetrate into the lower non-magnetic layer. Redissolution at the interface between the upper and lower layers during the film-forming step can be prevented. Furthermore, the drying speed of the magnetic layer is appropriately suppressed. Thus, if a thin magnetic layer is formed, a practically sufficient degree of orientation can be ensured.

Furthermore, according to an embodiment of the present invention, there is provided a high-density magnetic recording medium having a satisfactory surface smoothness and excellent electromagnetic conversion characteristics.

### BRIEF DESCRIPTION OF THE DRAWINGS

FIGURE is a schematic structural view of a magnetic recording medium according to an embodiment of the present invention.

### DESCRIPTION OF THE PREFERRED EMBODIMENTS

A magnetic recording medium and a production process thereof according to an embodiment of the present invention will now be described in detail with reference to the drawing. However, the present invention is not limited to the following examples.

A magnetic recording medium according to an embodiment of the present invention is of a high-density type. The magnetic recording medium is applied to a magnetoresistive head (MR head) or a giant magnetoresistive head (GMR head) serving as a read head. As shown in an exemplary schematic cross-sectional view of FIGURE, the magnetic recording medium includes a non-magnetic supporter 1, a lower non-magnetic layer 2, a magnetic layer 3, and a back coat layer 4, the non-magnetic supporter 1 and the lower non-magnetic layer 2 being laminated on a main surface of the non-magnetic supporter 1, the back coat layer 4 being provided on another main surface of the non-magnetic supporter 1.

These layers will be described below.

The non-magnetic supporter 1 may be composed of any one of materials used for known magnetic recording media.

Specific examples thereof include polyesters, such as poly(ethylene terephthalate) and poly(ethylene naphthalate); polyolefins, such as polyethylene and polypropylene; cellulose derivatives, such as cellulose triacetate, cellulose diacetate, and cellulose acetate butylate; vinyl resins, such as poly(vinyl chloride) and poly(vinylidene chloride); plastics, such as polycarbonate, polyimide, polyamide, and polyamide-imide; paper; metals, such as aluminum and copper; light alloys, such as aluminum alloys and titanium alloys; ceramics; and single-crystal silicon.

These may be used alone or in combination.

The shape of the non-magnetic supporter is appropriately determined by the shape of a target magnetic recording medium and may be in the form of a film, a tape, a sheet, a disc, a card, or a drum.

The lower non-magnetic layer 2 will be described below.

The lower non-magnetic layer 2 is formed by mixing inorganic particles, a binder resin, and other additives in an organic solvent, and then applying the resulting paint.

Inorganic particles used for forming a non-magnetic layer serving as a lower layer under a magnetic layer in a known magnetic recording medium may be used as inorganic particles constituting the lower non-magnetic layer 2.

Examples of the material of the inorganic particles include alumina, iron oxide, silicon carbide, chromium oxide, cerium oxide, goethite, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, and molybdenum disulfide. These may be used alone or in combination.

The shape of the inorganic particles may be acicular, spherical, flat, or cubic.

To prevent electrostatic damage to a highly sensitive magnetic head, such as an MR head or a GMR head, used for a target magnetic recording medium, a conducting agent is preferably incorporated. Any known conducting agents may be used. Examples thereof include carbon black and conductive titanium oxide.

Any known binder resin may be used as the binder resin incorporated in the lower non-magnetic layer 2.

Examples thereof include vinyl chloride-vinyl acetate copolymers, vinyl chloride-vinyl acetate-vinyl alcohol copolymers, vinyl chloride-vinyl acetate-maleic acid copolymers, vinyl chloride-vinylidene chloride copolymers, vinyl chloride-acrylonitrile copolymers, acrylic acid ester-acrylonitrile copolymers, acrylic acid ester-vinylidene chloride copolymers, methacrylic acid-vinylidene chloride copolymers, methacrylic acid ester-styrene copolymers, thermoplastic polyurethane resins, phenoxy resin, polyvinyl fluorides, vinylidene chloride-acrylonitrile copolymers, butadiene-acrylonitrile copolymers, acrylonitrile-butadiene-methacrylic acid copolymers, polyvinyl butyral, cellulose derivatives, styrene-butadiene copolymers, polyester resins, phenol resins, epoxy resins, thermosetting polyurethane resins, urea resins, melamine resins, alkyd resins, urea-formaldehyde resins; and mixtures thereof.

In particular, polyurethane resins, polyester resins, acrylonitrile-butadiene copolymers, or the like, which have the effect of imparting flexibility, are preferred. Cellulose derivatives, phenol resins, or epoxy resins, which have the effect of imparting stiffness, are also preferred. To improve durability, each of the binder resins may contain an isocyanate compound serving as a cross-linking agent.

Any known organic solvent may be used for the organic solvent for preparing the paint. Examples thereof include ketone solvents, such as acetone, methyl ethyl ketone, methyl isobutyl ketone, and cyclohexanone; ester solvents, such as methyl acetate, ethyl acetate, butyl acetate, ethyl lactate, and ethylene glycol monoethyl ether acetate; glycol ether solvents, such as glycol monoethyl ether and dioxane; aromatic hydrocarbon solvents, such as benzene, toluene, and xylenes; and organnochlorine compound solvents, such as methylene chloride, ethylene chloride, carbon tetrachloride, chloroform, ethylene chlorohydrin, and dichlorobenzene.

The lower non-magnetic layer 2 is dried before forming the magnetic layer 3.

In this case, the lower non-magnetic layer 2 is not subjected to any surface treatment, such as calendering, heat curing, or electron-beam irradiation. The formation of the magnetic layer, which is post production treatment, is performed while the lower non-magnetic layer 2 is maintained in a film state after drying.

These treatments, such as calendering and surface curing, occlude pores in the lower non-magnetic layer 2. Thus, the resulting lower non-magnetic layer 2 cannot absorb the organic solvent in the magnetic paint.

The magnetic layer 3 will be described below.

The magnetic layer 3 is formed by applying a paint prepared by mixing at least a magnetic powder and a binder resin.

Ferromagnetic particles applied to a paint used for a known magnetic recording medium may be used as the magnetic powder.

Examples of the material of the magnetic powder include ferromagnetic iron oxide, ferromagnetic chromium dioxide, ferromagnetic barium ferrite, ferromagnetic alloys, ferromagnetic iron-platinum alloys, and ferromagnetic iron nitride.

Any one of binders used for paints used for known magnetic recording media may be used for a paint for forming the magnetic layer 3. Specifically, any one of the above-described binder resins for forming the lower non-magnetic layer may be applied.

Any one of organic solvents used for known paints may be used as the organic solvent used for preparing the magnetic paint. Any one of the above-described organic solvents used for forming the lower non-magnetic layer may be applied.

The thickness of the magnetic layer 3 is set at 100 nm or less.

It is desirable to provide an extremely high-density magnetic recording medium according to an embodiment of the present invention. The magnetic layer 3 having a thickness exceeding 100 nm increases PW50 (the width of an isolated pulse at 50% of its amplitude), thus degrading high-density recording properties.

In the case in which signals are read with a high-sensitivity magnetic read head, such as an MR head or a GMR head, if the thickness of the magnetic layer exceeds 100 nm, the saturation magnetization Br of the magnetic layer is 0.25 T or higher. Saturation occurs depending on the specifications of the read head (for example, the saturation magnetic flux densities and thicknesses of an MR element and a soft adjacent layer (SAL)), thus degrading electromagnetic conversion characteristics (C/N).

The back coat layer 4 can be composed of inorganic particles, a lubricant, and various additives, such as an antistatic agent.

The lower non-magnetic layer 2 and the magnetic layer 3 may also be laminated in place of the back coat layer 4 to form a high-capacity magnetic recording medium having recording layers on both main surfaces thereof.

A process for producing a magnetic recording medium 10 according to an embodiment of the present invention will be described below.

A predetermined non-magnetic supporter 1 in response to a target magnetic recording medium is first prepared.

Paints for forming the lower non-magnetic layer 2 and the magnetic layer 3 are prepared.

These paints are prepared by dispersing the above-described materials by kneading with a predetermined solvent.

A method for dispersing the materials by kneading may be any known method and is not particularly limited. For example, a method of using a continuous twin-screw extruder, a co-kneader, a pressure kneader, or the like may be employed.

The lower non-magnetic layer 2 is formed by applying a non-magnetic paint by a known application method, such as gravure coating, extrusion coating, air doctor coating, or reverse roll coating, and subsequently drying the applied paint.

A magnetic paint is applied onto the lower non-magnetic layer 2 by a known application method, such as gravure coating, extrusion coating, air doctor coating, or reverse roll coating, while the lower non-magnetic layer 2 is maintained in a film state after drying.

Magnetic orientation is performed with an orientation apparatus in an undried state such that the magnetic particles in the magnetic paint have the degree of freedom. Then, drying is performed with a dryer.

Subsequently, calendering and surface curing are performed. If necessary, the back coat layer 4 is formed. Thereby, the magnetic recording medium 10 according to an embodiment ob the present invention is produced.

Any one of known magnetic powders, binder resins, inorganic particles, additives, such as dispersants, abrasives, antistatic agents, and anticorrosives, and organic solvents for preparing paints may be applied. These materials are not particularly limited.

### EXAMPLES

As described below, an exemplary magnetic tape was produced, and physical properties were measured, and evaluation was performed. However, the present invention is not limited to these examples.

### (Example 1 to 15) and (Comparative Example 1 to 25)

Magnetic paints having compositions described below were prepared.

With respect to magnetic paints, magnetic particles were appropriately selected from the magnetic particles shown in Table 1 described below, and dispersions for forming magnetic layers were prepared.

TABLE 1

| | Long-axis | Short-axis | Coercive | Magne- | |
|---|---|---|---|---|---|
| | length | length | force | tization | Shape, |
| | (nm) | (nm) | (kA/m) | (Am/kg) | material |
| Dispersion A | 30 | 10 | 206 | 112 | Acicular, |
| | | | | | Fe—Co |
| Dispersion B | 60 | 16 | 213 | 127 | Acicular, |
| | | | | | Fe—Co |
| Dispersion C | 5 | 5 | 210 | 55 | Spherical, |
| | | | | | Pt—Co |

[Composition of Magnetic Paint]
Magnetic powder (selected from Table 1): 100 parts by weight
First binder: 9 parts by weight (vinyl chloride copolymer (mean degree of polymerization: 300))
Second binder: 9 parts by weight (polyester polyurethane resin (weight-average molecular weight: 41,200, Tg: 40° C.))
Lubricant: stearic acid: 1 part by weight : butyl stearate: 2 parts by weight
Solvent: methyl ethyl ketone: 20 parts by weight : toluene: 20 parts by weight : cyclohexanone: 10 parts by weight

The above-described materials were kneaded with a kneader. The resulting mixture was diluted with methyl ethyl ketone, toluene, and cyclohexanone. The materials were dispersed with a sand mill to form a dispersion.

Then, 4 parts by weight of polyisocyanate (curing agent “Colonate L”, produced by Nippon Polyurethane Industry Co., Ltd.) was added thereto. The resulting mixture was stirred to prepare a paint for forming a magnetic layer.

As described below, a paint for forming a lower non-magnetic layer was prepared.

[Composition of Dispersion for Forming Lower Non-Magnetic Layer]

First inorganic particles: α-iron oxide (long-axis length: 50 nm, BET value: 87 m²/g): 100 parts by weight
Second inorganic particles: carbon black: 24 parts by weight (particle size: 20 nm, DBP oil absorption: 120 mL/100 g)
First binder: vinyl chloride copolymer (mean degree of polymerization: 300): 9 parts by weight
Second binder: polyester polyurethane resin: 9 parts by weight (weight-average molecular weight: 41,200, Tg: 40° C.)
Lubricant: butyl stearate: 2 parts by weight : stearic acid: 1 part by weight
Organic solvent: methyl ethyl ketone: 20 parts by weight : toluene: 20 parts by weight : cyclohexanone: 10 parts by weight

The above-described materials were kneaded, diluted with the organic solvents, and dispersed with a sand mill to produce a dispersion for forming a lower non-magnetic layer.

Then, 3 parts by weight of polyisocyanate (curing agent “Colonate L”, produced by Nippon Polyurethane Industry Co., Ltd.) was added thereto relative to 100 parts by weight of the first inorganic particles to prepare a paint for forming a lower non-magnetic layer.

### Examples 1 to 15

As a non-magnetic supporter, a poly(ethylene terephthalate) having a thickness of 5.0 μm was prepared. The resulting paint for forming a lower non-magnetic layer was applied thereon in a manner such that the resulting non-magnetic layer had a predetermined thickness (see Table 2 described below), and the applied paint was dried.

The paint for forming a magnetic layer was applied onto the lower non-magnetic layer in a manner such that the resulting magnetic layer had a predetermined thickness (100 nm or less, see Table 2) while the lower non-magnetic layer was maintained in a film state after drying.

The resulting film was subjected to magnetic field orientation treatment and drying, and was then wound. Subsequently, the film was subjected to calendering and curing.

Then, 10 parts by weight of polyisocyanate (curing agent “Colonate L”, produced by Nippon Polyurethane Industry Co., Ltd.) was added to a dispersion for forming a back coat layer, the dispersion having a composition described below, to prepare a paint for forming a back coat layer. The resulting paint was applied onto another main surface opposite the surface on which the magnetic layer was provided to form a back coat layer having a thickness of 0.6 μm.

[Composition of Dispersion for Forming Back Coat Layer]

Inorganic powder (carbon black): 100 parts by weight (particle size: 40 nm, DBP oil absorption: 112.0 mL/100 g)
Binder: polyester polyurethane resin: 13 parts by weight (weight-average molecular weight: 71,200)
Binder: phenoxy resin (mean degree of polymerization: 100): 43 parts by weight
Binder: nitrocellulose resin (mean degree of polymerization: 90): 10 parts by weight
solvent: methyl ethyl ketone: 500 parts by weight : toluene: 500 parts by weight

The resulting wide magnetic tape was slit into strips having a width of 8 mm. The resulting strips were used as sample magnetic recording tapes in Examples 1 to 15.

### Comparative Example 1 to 5

The paint for forming a lower non-magnetic layer was applied in a manner such that the resulting non-magnetic layer had a predetermined thickness (see Table 3), and the applied paint was dried. To smooth the surface, calendering (roller temperature: 100° C., linear load: 300 kgf/cm) was performed.

Curing treatment was performed at 60° C. for 24 hours.

The magnetic paint described above was applied onto the lower non-magnetic layer in a manner such that the resulting magnetic layer had a predetermined thickness (see Table 3 described below).

This procedure for forming the magnetic layer is referred to as α step shown in Table 2 described below.

Subsequently, the resulting film was subjected to magnetic field orientation treatment and drying, and was then wound. Subsequently, calendering and curing were performed.

Then, 10 parts by weight of polyisocyanate (curing agent “Colonate L”, produced by Nippon Polyurethane Industry Co., Ltd.) was added to a dispersion for forming a back coat layer, the dispersion having a composition described above, to prepare a paint for forming a back coat layer. The resulting paint was applied onto another main surface opposite the surface on which the magnetic layer was provided to form a back coat layer having a thickness of 0.6 μm.

Other steps were performed as in Examples 1 to 15 to produce a sample magnetic tape.

Comparative Example 6 to 10

The paint for forming a lower non-magnetic layer was applied in a manner such that the resulting non-magnetic layer had a predetermined thickness (see Table 3), and the applied paint was dried. To smooth the surface, calendering (roller temperature: 100° C., linear load: 300 kgf/cm) was performed.

The magnetic paint described above was applied in a manner such that the resulting magnetic layer had a predetermined thickness (see Table 3 described below).

This procedure for forming the magnetic layer is referred to as β step shown in Table 2 described below.

Subsequently, the resulting film was subjected to magnetic field orientation treatment and drying, and was then wound. Subsequently, calendering and curing were performed.

Then, 10 parts by weight of polyisocyanate (curing agent “Colonate L”, produced by Nippon Polyurethane Industry Co., Ltd.) was added to a dispersion for forming a back coat layer, the dispersion having a composition described above, to prepare a paint for forming a back coat layer. The resulting paint was applied onto another main surface opposite the surface on which the magnetic layer was provided to form a back coat layer having a thickness of 0.6 μm.

Other steps were performed as in Examples 1 to 15 to produce a sample magnetic tape.

### Comparative Example 11 to 15

The paint for forming a lower non-magnetic layer was applied in a manner such that the resulting non-magnetic layer had a predetermined thickness (see Table 3), and the applied paint was dried. Curing treatment was performed at 60° C. for 24 hours.

The magnetic paint described above was applied in a manner such that the resulting magnetic layer had a predetermined thickness (see Table 3 described below).

This procedure for forming the magnetic layer is referred to as γ step shown in Table 2 described below.

Subsequently, the resulting film was subjected to magnetic field orientation treatment and drying, and was then wound. Subsequently, calendering and curing were performed.

Then, 10 parts by weight of polyisocyanate (curing agent “Colonate L”, produced by Nippon Polyurethane Industry Co., Ltd.) was added to a dispersion for forming a back coat layer, the dispersion having a composition described above, to prepare a paint for forming a back coat layer. The resulting paint was applied onto another main surface opposite the surface on which the magnetic layer was provided to form a back coat layer having a thickness of 0.6 μm.

Other steps were performed as in Examples 1 to 15 to produce a sample magnetic tape.

### Comparative Example 16 to 20

The paint for forming a lower non-magnetic layer was applied in a manner such that the resulting non-magnetic layer had a predetermined thickness (see Table 3), and the applied paint was dried. The magnetic paint was applied onto the applied paint for forming the lower non-magnetic layer in a wet state (i.e., a wet-on-wet method) in a manner such that the resulting magnetic layer had a predetermined thickness (see Table 3).

Subsequently, the resulting film was subjected to magnetic field orientation treatment and drying, and was then wound. Subsequently, calendering and curing were performed.

Then, 10 parts by weight of polyisocyanate (curing agent “Colonate L”, produced by Nippon Polyurethane Industry Co., Ltd.) was added to a dispersion for forming a back coat layer, the dispersion having a composition described above, to prepare a paint for forming a back coat layer. The resulting paint was applied onto another main surface opposite the surface on which the magnetic layer was provided to form a back coat layer having a thickness of 0.6 μm.

Other steps were performed as in Examples 1 to 15 to produce a sample magnetic tape.

### Comparative Example 21 to 23

The paint for forming a lower non-magnetic layer was applied in a manner such that the resulting non-magnetic layer had a predetermined thickness (see Table 3), and the applied paint was dried.

The magnetic paint was applied in a manner such that the resulting magnetic layer had a thickness of 150 nm, while the lower non-magnetic layer was maintained in a film state after drying.

Subsequently, the resulting film was subjected to magnetic field orientation treatment and drying, and was then wound. Subsequently, calendering and curing were performed.

Then, 10 parts by weight of polyisocyanate (curing agent “Colonate L”, produced by Nippon Polyurethane Industry Co., Ltd.) was added to a dispersion for forming a back coat layer, the dispersion having a composition described above, to prepare a paint for forming a back coat layer. The resulting paint was applied onto another main surface opposite the surface on which the magnetic layer was provided to form a back coat layer having a thickness of 0.6 μm.

Other steps were performed as in Examples 1 to 15 to produce a sample magnetic tape.

### Comparative Example 24

The magnetic paint was applied in a manner such that the resulting magnetic layer had a thickness of 110 nm.

Other steps were performed as in Examples 1 to 15 to produce a sample magnetic tape.

### Comparative Example 25

The magnetic paint was applied in a manner such that the resulting magnetic layer had a thickness of 3 nm.

Other steps were performed as in Examples 1 to 15 to produce a sample magnetic tape.

In each resulting sample magnetic recording tapes produced in Examples 1 to 15 and Comparative Example 1 to 23, magnetostatic properties, the state of the interface between the magnetic layer and the lower non-magnetic layer, the shape of the surface of the magnetic layer, electromagnetic conversion characteristics, and a dropout were measured and evaluated. Measurement processes will be described below.

[Measurement and Evaluation of Thickness of Magnetic Layer and Interface Between Upper and Lower Layers]

First, ten test pieces were cut out from each sample magnetic tape in the longitudinal direction. Each of the test pieces was cut parallel to the longitudinal direction by microtome sectioning.

The cross-section of each test piece was observed at a magnification of 60,000 or more with a transmission electron microscope (TEM) (Model: JEM-200CX, produced by JEOL Ltd.), and the thicknesses of the magnetic layer were measured at 20 positions or more on the cross-section of each test piece.

The average of the thicknesses measured at the 20 positions or more on the cross-section of each test piece was calculated and was defined as the thickness of the sample magnetic tape. Tables 2 and 3 show the thicknesses of the sample magnetic tapes.

The distances from the surface of the magnetic layer to the interface between the magnetic layer and the lower non-magnetic layer were measured at 20 positions or more on the cross-section of each test piece. The distance at each position was defined as a “thickness (0-p) value” at each position.

The distribution of at least 20 thickness (0-p) values measured in each test piece was investigated. The ratio of the difference between the minimum value and the maximum value to the thickness of the magnetic layer was calculated and was defined as “the degree of fluctuation at the interface between the upper and lower layers”.

The degree of fluctuation at the interface between the upper and lower layers was calculated relative to that in Comparative Example 2 and was evaluated according to the following criteria:

1.15 or less: good

1.15 to 1.25: fair

1.25 to 1.4: poor

more than 1.4: terrible.

Tables 2 and 3 show the evaluation results.

[Magnetostatic Properties]

A magnetic field was applied to each sample in the longitudinal direction of the sample at a maximum applied magnetic field of 1.5 T with a vibrating sample magnetometer (Model: VSM-P15 AUTO, produced by Toei Industry Co., Ltd.) to determine a hysteresis curve.

From the resulting hysteresis curve, the ratio of magnetization at the maximum applied magnetic field (Ms) to magnetization at an applied magnetic field of 0 (Mr), i.e., Rs=Ms/Mr, was determined and was defined as the degree of orientation.

Tables 2 and 3 show the degree of orientation of each sample magnetic tape.

[Surface Smoothness of Magnetic Layer]

The surface roughness of the magnetic layer of each sample magnetic tape was measured at least 10 times in an area of 50×50 μm² with an atomic force microscope (Model: Nano Scope IIIa/D-3000, produced by Digital Instruments). Measurement positions were changed each time.

In each measurement, the resolution was set at 256×256 pixels.

In each measurement, a predetermined computation was performed with each pixel to determine an index representing surface properties, i.e., average surface roughness SRa (nm) The average of SRa values obtained was defined as the true value of SRa of each magnetic recording medium.

Tables 2 and 3 show SRa of each sample magnetic tape.

[Electromagnetic Conversion Characteristics]

Electromagnetic conversion characteristics of each sample magnetic tape were evaluated with an evaluation apparatus including a write head (MIG, gap: 0.15 μm) and a read head (GMR, gap: 0.15 μm).

After a signal having a wavelength of 0.25 μm was recorded, an output signal and noise were measured with a spectrum analyzer.

The intensity of a frequency component with a frequency range of a read signal±2 MHz was defined as a noise level. The ratio of a noise output to a read signal output was defined as a C/N characteristic.

The C/N characteristic of the sample magnetic tape in Comparative Example 2 was defined as a reference value (0.0 dB). The C/N characteristic of each sample magnetic tape was defined as a relative value to the reference value.

Tables 2 and 3 show the C/N characteristics of sample magnetic tapes.

[Dropout]

Measurement samples were made by incorporating the sample magnetic tapes in 8-mm data cartridge.

Each of the measurement samples were run with a 8-mm driving apparatus, and a signal having a wavelength of 0.25 μm was recorded for 10 minutes under a temperature of 25° C. and a humidity of 50%.

The signal was read. At least −6 dB of a reduction in output continued for 0.3 μsec or more relative to the envelope of the output signal was defined as dropout. The number of occurrences per minute was measured.

The average of 10 data sets measured for 10 minutes was defined as the true value of the dropout.

The dropout was evaluated in comparison with the dropout of the sample magnetic tape in Comparative Example 2, and evaluation criteria were as follows:

Up to 0.9 times: good

0.9 to 1.5 times: fair

at least 1.5 times: poor

Tables 2 and 3 show the evaluations of the dropouts of the sample magnetic tapes.

TABLE 2

| | | | Thickness of | | Thickness | Fluctuation | | | | |
|---|---|---|---|---|---|---|---|---|---|---|
| | | | lower non- | | of magnetic | at interface | Degree of | | | |
| | Application | Intermediate | magnetic | Magnetic | layer | between upper | orientation | Smoothness | C/N | |
| | method | step | layer (μm) | dispersion | (nm) | and lower layers | Rs (%) | SRa (%) | (dB) | Dropout |
| Example 1 | Sequential | absent | 1.0 | Dispersion A | 100 | Good | 89 | 3.5 | 0.7 | Good |
| Example 2 | Sequential | absent | 1.0 | Dispersion A | 50 | Good | 88 | 3.5 | 0.7 | Good |
| Example 3 | Sequential | absent | 1.0 | Dispersion A | 30 | Good | 86 | 3.6 | 0.6 | Good |
| Example 4 | Sequential | absent | 0.5 | Dispersion A | 30 | Good | 87 | 3.6 | 0.5 | Good |
| Example 5 | Sequential | absent | 1.5 | Dispersion A | 30 | Good | 86 | 3.5 | 0.6 | Good |
| Example 6 | Sequential | absent | 2.5 | Dispersion A | 30 | Good | 85 | 3.5 | 0.7 | Good |
| Example 7 | Sequential | absent | 1.0 | Dispersion A | 10 | Good | 85 | 3.6 | 0.5 | Good |
| Example 8 | Sequential | absent | 1.0 | Dispersion B | 100 | Good | 87 | 3.6 | 0.9 | Good |
| Example 9 | Sequential | absent | 1.0 | Dispersion B | 50 | Good | 87 | 3.7 | 0.9 | Good |
| Example 10 | Sequential | absent | 1.0 | Dispersion B | 30 | Good | 85 | 3.7 | 0.7 | Good |
| Example 11 | Sequential | absent | 1.0 | Dispersion B | 16 | Good | 84 | 3.8 | 0.7 | Good |
| Example 12 | Sequential | absent | 1.0 | Dispersion C | 100 | Good | 86 | 3.7 | 0.6 | Good |
| Example 13 | Sequential | absent | 1.0 | Dispersion C | 50 | Good | 86 | 3.7 | 0.5 | Good |
| Example 14 | Sequential | absent | 1.0 | Dispersion C | 30 | Good | 84 | 3.7 | 0.5 | Good |
| Example 15 | Sequential | absent | 1.0 | Dispersion C | 5 | Good | 84 | 3.8 | 0.5 | Good |

TABLE 3

| | | | Thickness | | | Fluctuation | | | | |
|---|---|---|---|---|---|---|---|---|---|---|
| | | | of lower | | Thickness | at interface | Degree | | | |
| | | Inter- | non- | | of magnetic | between | of orien- | Smooth- | | |
| | Application | mediate | magnetic | Magnetic | layer | upper and | tation | ness | C/N | |
| | method | step | layer (μm) | dispersion | (nm) | lower layers | Rs (%) | SRa (%) | (dB) | Dropout |
| Comparative Example 1 | Sequential | α step | 1.0 | Dispersion A | 150 | Good | 85 | 4.0 | −0.5 | Poor |
| Comparative Example 2 | Sequential | α step | 1.0 | Dispersion A | 100 | Good | 78 | 4.8 | 0.0 | fair |
| Comparative Example 3 | Sequential | α step | 1.0 | Dispersion A | 50 | Good | 72 | 4.9 | −0.2 | fair |
| Comparative Example 4 | Sequential | α step | 1.0 | Dispersion A | 30 | Good | 68 | 5.1 | −0.4 | Poor |
| Comparative Example 5 | Sequential | α step | 1.0 | Dispersion A | 10 | Good | 65 | 5.2 | −0.5 | Poor |
| Comparative Example 6 | Sequential | β step | 1.0 | Dispersion A | 150 | Good | 85 | 4.0 | −0.4 | Poor |
| Comparative Example 7 | Sequential | β step | 1.0 | Dispersion A | 100 | Good | 79 | 4.8 | 0.1 | fair |
| Comparative Example 8 | Sequential | β step | 1.0 | Dispersion A | 50 | Good | 76 | 4.9 | −0.1 | fair |
| Comparative Example 9 | Sequential | β step | 1.0 | Dispersion A | 30 | Good | 69 | 4.9 | −0.3 | Poor |
| Comparative Example 10 | Sequential | β step | 1.0 | Dispersion A | 10 | Good | 65 | 5.2 | −0.4 | Poor |
| Comparative Example 11 | Sequential | γ step | 1.0 | Dispersion A | 150 | Good | 85 | 4.1 | −0.4 | Poor |
| Comparative Example 12 | Sequential | γ step | 1.0 | Dispersion A | 100 | Good | 80 | 4.9 | 0.2 | fair |
| Comparative Example 13 | Sequential | γ step | 1.0 | Dispersion A | 50 | Good | 78 | 4.9 | 0.0 | fair |
| Comparative Example 14 | Sequential | γ step | 1.0 | Dispersion A | 30 | Good | 70 | 5.0 | −0.3 | Poor |
| Comparative Example 15 | Sequential | γ step | 1.0 | Dispersion A | 10 | Good | 66 | 5.0 | −0.5 | Poor |
| Comparative Example 16 | Simultaneous | — | 1.0 | Dispersion A | 150 | Poor | 90 | 3.6 | −0.2 | Good |
| Comparative Example 17 | Simultaneous | — | 1.0 | Dispersion A | 100 | Poor | 89 | 4.1 | 0.3 | fair |
| Comparative Example 18 | Simultaneous | — | 1.0 | Dispersion A | 50 | Terrible | 87 | 3.7 | −0.5 | Poor |
| Comparative Example 19 | Simultaneous | — | 1.0 | Dispersion A | 30 | Terrible | 87 | 3.8 | −0.8 | Poor |
| Comparative Example 20 | Simultaneous | — | 1.0 | Dispersion A | 10 | Terrible | 85 | 3.8 | −1.5 | Poor |
| Comparative Example 21 | Sequential | absent | 1.0 | Dispersion A | 150 | fair | 89 | 3.5 | −0.1 | Good |
| Comparative Example 22 | Sequential | absent | 1.0 | Dispersion B | 150 | fair | 87 | 3.6 | −0.1 | Good |
| Comparative Example 23 | Sequential | absent | 1.0 | Dispersion C | 150 | fair | 86 | 3.6 | −0.1 | Good |
| Comparative Example 24 | Sequential | absent | 1.0 | Dispersion A | 110 | fair | 89 | 3.5 | −0.1 | Good |
| Comparative Example 25 | Sequential | absent | 1.0 | Dispersion C | 3 | fair | 83 | 3.6 | 0.1 | Poor |

As shown in Table 2, in Examples 1 to 15 each in which the magnetic layer having a thickness of 100 nm or less was formed by only drying the lower non-magnetic layer 2 containing the binder resin and the inorganic particles without performing calendering and curing, and then applying the magnetic paint, the solvent in the magnetic paint appropriately penetrated into the lower non-magnetic layer 2, thereby preventing application defects due to irregularities of the interface between the upper and lower layers. Furthermore, the solvent was appropriately transferred from the lower layer to the upper layer, thus reducing the drying speed of the magnetic layer. Therefore, the magnetic layer was subjected to magnetic field orientation treatment to achieve practically sufficient orientation. Thereby, a high-reliability magnetic recording medium having satisfactory electromagnetic conversion characteristics and very few dropouts was produced.

In contrast, in Comparative Examples 2 to 5, 7 to 10, and 12 to 15 each in which the magnetic layer having a thickness of 100 nm or less was formed by drying the lower non-magnetic layer 2 containing the binder resin and the inorganic particles, performing at least one treatment selected from calendering and curing, and then applying the magnetic paint, the solvent in the magnetic layer hardly penetrate into the lower non-magnetic layer. Thus, the drying speed of the magnetic layer could not be reduced. Even if magnetic field orientation treatment was performed, the degree of orientation was not sufficiently increased, thereby resulting in an unsatisfactory remanence ratio.

In each of Comparative Examples 1, 5, and 11, since the thickness of the magnetic layer was 150 nm greater than the other samples, the drying speed of the magnetic layer could be reduced. As a result, the degree of orientation was increased to achieve a high remanence ratio. However, since the signal was read with a high-sensitivity head (GMR head), noise was increased, thus degrading electromagnetic conversion characteristics.

In Comparative Examples 16 to 20 each in which the lower non-magnetic layer and the magnetic layer were laminated by a wet-on-wet method, application defects and the deterioration of the surface state of the magnetic layer were caused by fluctuation at the interface between the upper and lower layers. In particular, in Comparative Examples 17 to 20 each in which the thin magnetic layer having a thickness of 100 nm or less was formed, the occurrence of the dropout was increased.

In Comparative Examples 21 to 25 each in which the film-forming steps were identical to those in Examples 1 to 15 except that the thickness of the magnetic layer was changed, when the thickness of the magnetic layer exceeded 100 nm, an excessive amount of the solvent was transferred from the magnetic layer to the lower non-magnetic layer to cause fluctuation at the interface between the upper and lower layers because the upper and lower layers were mixed, thereby degrading electromagnetic conversion characteristics.

On the other hand, Comparative Example 25 in which the thickness of the magnetic layer was smaller than the axial length of each of the magnetic particles in the magnetic paint, the drying speed of the magnetic layer was very high. The magnetic particles were exposed to the surface of the magnetic layer, in some cases, thereby increasing the occurrence of the dropout. That is, it was confirmed that the thickness of the magnetic layer was suitably in the range from the minimum diameter of a magnetic particle used to 100 nm or less.

It should be understood by those skilled in the art that various modifications, combinations, sub-combinations and alterations may occur depending on design requirements and other factors insofar as they are within the scope of the appended claims or the equivalents thereof.

What is claimed is:

1. A magnetic recording medium comprising:
a non-magnetic supporter;
a lower non-magnetic layer containing at least inorganic particles and a binder resin; and
a magnetic layer containing at least a magnetic powder and a binder resin and having a thickness of 100 nm or less, the lower non-magnetic layer and the magnetic layer being laminated on a main surface of the non-magnetic supporter,
wherein the magnetic layer is formed by a process including:
applying a paint for forming the lower non-magnetic layer;
drying the applied paint; and
applying a magnetic paint while the lower non-magnetic layer is kept in a film state after drying.

2. The magnetic recording medium according to claim 1, wherein the magnetic recording medium is applied to a magnetoresistive head or a giant magnetoresistive head serving as a read head.

3. A process for producing a magnetic recording medium including:
a non-magnetic supporter;
a lower non-magnetic layer containing at least inorganic particles and a binder resin; and
a magnetic layer containing at least a magnetic powder and a binder resin and having a thickness of 100 nm or less, the lower non-magnetic layer and the magnetic layer being laminated on a main surface of the non-magnetic supporter, the process comprising the steps of:
applying a non-magnetic paint containing at least inorganic particles dispersed in a binder resin onto at least one main surface of the non-magnetic supporter;
drying the applied paint to form the lower non-magnetic layer; and
applying a magnetic paint containing at least a magnetic powder dispersed in a binder resin onto the lower non-magnetic layer that is maintained in a film state after drying, to form a magnetic layer.

4. The process for producing the magnetic recording medium according to claim 3, wherein the resulting magnetic recording medium is applied to a magnetoresistive head or a giant magnetoresistive head serving as a read head.
